(19) United States
(12) Patent Application Publication
(10) Pub. No.: US 2007/0062360 A1
(43) Pub. Date: Mar. 22, 2007

(54) Power cutter for hardened steel workpiece

(75) Inventors: Christian Hielscher, Delbruck (DE); Hans-Jurgen Knaup, Bad Lippspringe (DE)

Correspondence Address: THE FIRM OF KARL F ROSS, 5676 RIVERDALE AVENUE, PO BOX 900, RIVERDALE (BRONX), NY, 10471-0900, US

(73) Assignee: Benteler Automobiltechnik GmbH

(21) Appl. No.: 11/521,062

(22) Filed: Sep. 13, 2006

(30) Foreign Application Priority Data
Sep. 22, 2005 (DE) 102005045454.2

(51) Int. Cl. B26D 1/00

(52) U.S. Cl. 83/694

(57) ABSTRACT

A power cutter for cutting a hardened steel workpiece has upper and lower press plates shiftable vertically relative to each other, a lower blade on the lower plate adapted to support the workpiece and having a lower cutting edge upwardly engaging the workpiece, and an upper blade on the upper plate having an upper cutting edge substantially parallel to and movable vertically past the lower cutting edge. An actuator connected to one of the plates vertically shifts the one plate toward and away from the other plate. An abutment on at least one of the plates bearing on the other of the plates and blocks vertical shifting of the plates toward each other in a position with the upper cutting edge slightly above the lower cutting edge.

### FIELD OF THE INVENTION

The present invention relates to a power cutter. More particularly this invention concerns such a press or cutter intended to cut a hardened steel workpiece.

### BACKGROUND OF THE INVENTION

A typical power cutter for cutting a hardened steel workpiece has lower and upper press plates shiftable vertically relative to each other, a lower blade on the lower plate adapted to support the workpiece and having a lower cutting edge upwardly engaging the workpiece, and an upper blade on the upper plate having an upper cutting edge movable vertically past the lower cutting edge. An actuator, typically a massive hydraulic ram, can vertically shift the one plate, normally the upper plate, toward and away from the other plate so that a workpiece on the lower blade is cut between the edges. Unlike a standard shear where the two cutting edges extend at a small acute angle to each other so that the cutting takes place progressively across the cut line, with the power-cutting press of this invention the two cutting edges are always parallel to each other so that the entire cut is formed as an initial stage where the edges bite into the workpiece, then as a single fracturing stage when the workpiece breaks in a line (normally a plane) between the cutting edges.

In such presses, a problem is the so called cutting shock that has to be damped to reduce noise, but also due to the load of the tool and the machine caused by it. When the workpiece fractures, the resistance offered to the cutting plates goes from very great to zero in an instant, unlike a shear where the force rises from zero to a certain level, stays at that level as the cut advances along the cut line, then returns to zero then goes smoothly back to zero as the cut is completed. Cutting shock is caused by the fact that during cutting, the workpiece resists only until a determined penetration depth of the cutting tool into the workpiece is achieved. After this initial phase of cutting, the workpiece fractures along the cut line and the relatively high cutting force acts upon the ram to cause an elastic strain of the entire ram structure and an elastic elongation of the frame of the press. When the cutting tool has exceeded a determined penetration depth (shear fraction), the residual material breaks (residual breaking fraction). Due to the low resistance, a relief of the stress of the elastically strained ram and of the lengthened frame of the press occurs that causes the so-called cutting shock.

For damping the cutting shock, it is known to attach damping elements adjacent the tool on the machine table or in the respective tool that function hydraulically by displacing hydraulic fluid that passes through a restriction, or by means of springs. In DE 41 21 142 of Kaiser, a press having a machine table, a ram that can be moved upward and downward and a clamping plate is disclosed, the ram and the clamping plate being provided with clamping or supporting elements for clamping the tool and with a cutting-shock damper that has several damping elements that are countersunk into the machine table that can be operated by means of adjustment columns that can be adjusted longitudinally. This way, the adjustment columns are fixed corresponding to the mounting position of the damping elements in a mobile master piece that can be moved into a working space of the press and again out of said working space. The known damping elements for damping the cutting shock thus are aimed at generating a braking force during the phase of the cutting fracture that acts against the sudden stress relief in the press.

From German utility model 78 09 007, a hydraulic press is known in which the effective surface area of the counterpressure piston is equal to or larger than the effective surface area of the piston of the press piston, and the counterpressure unit can work against the counterpressure of a cylinder-piston unit disposed on the same axis adjacent the cylinder-piston of the press ram, the counterpressure piston being traversed by a connection rod on the piston of the press ram that has on its outer end of an abutment that interacts with the counterpressure piston. This way, the press ram can practically no longer move after the cutting fracture and the press stops when the adjustable abutment is reached. Since the abutment however is on the upper part of the ram, the cutting shock cannot be damped properly; in particular, no variable control can be achieved within the press in this structure of presses.

When steel plates hardened for example to 1400 MPa and of a thickness of for example 2 mm are cut, the problem of cutting shock increases due to the fact that very high forces are required but only over a very short distance. Often, the cutting is effected over less than a third of the plate thickness. Additionally, as few burrs as possible should be generated during the cutting.

In a shearing operation as described above, the upper and lower cutting edges extend at an angle to each other such that the cutting process, as for a pair of scissors, is not effected simultaneously on the entire cut line, but gradually along it. This has the disadvantage that the blades where they are acting penetrate to a large extent into the workpiece and past each other, before the areas that are effective later have cut through the plate. Due to this movement, a considerably larger area of the surface area of the cutting elements is subject to wear caused by the high friction between the blades and the tool steel. Additionally, disadvantageous distortions and moments occur in the cutting process, since one side of the cutting elements has a shape different from that of the workpiece to be cut.

### OBJECTS OF THE INVENTION

It is therefore an object of the present invention to provide an improved power cutter for hardened steel workpiece.

Another object is the provision of such an improved power cutter for hardened steel workpiece that overcomes the above-given disadvantages, in particular that can cut or trim workpieces of hard materials without this cutting shock.

Yet another object is to provide an improved cutting method applicable to hard steel workpieces, in particular thin plates.

### SUMMARY OF THE INVENTION

A power cutter for cutting a hardened steel workpiece has according to the invention upper and lower press plates shiftable vertically relative to each other, a lower blade on the lower plate adapted to support the workpiece and having a lower cutting edge upwardly engaging the workpiece, and an upper blade on the upper plate having an upper cutting edge substantially parallel to and movable vertically past the lower cutting edge. An actuator connected to one of the plates vertically shifts the one plate toward and away from the other plate. An abutment on at least one of the plates bearing on the other of the plates and blocks vertical shifting of the plates toward each other in a position with the upper cutting edge slightly above the lower cutting edge.

Thus with the method of this invention the workpiece is supported on the lower blade so that the workpiece extends across the lower cutting edge. Then the plates are moved toward each other so that the cutting edges cut into the workpiece but do not move past each other and the blades are pressed together with the blades cutting into the workpiece until the workpiece fractures at the cutting edges. According to the invention further shifting-together of the blades is however blocked by interposition of an abutment between them to prevent the cutting edges from passing each other.

The abutment or spacer according to the invention is mounted within the tool as close as possible to a cutting area. With a press according to the invention, no shearing action is used. Instead, the press engages with its an upper and lower blades along their entire lengths on the workpiece to be cut. After the blades bite somewhat into the hardened-steel workpiece, it fractures and the tools seat on the spacers that are mounted on them. This way, the movement of the press is stopped and subsequent movement of the press past exceeds its predetermined path due to the cutting shock is prevented. Engagement on the abutment/spacers defines the maximumn traverse path of the press. The conventional damper for damping the cutting shock only brakes the movement of the press but cannot prevent a slight subsequent oscillatory movement. The extremely hard workpiece is cut without the formation of burrs by using a gap—measured transversely between the vertical planes in which the two cutting edges are displaced—that is as small as possible, advantageously zero. Due to the small thickness of the plate and due to the high forces, any oscillation of the press can lead to cutting of the upper blade into the lower blade and thus can destroy the cutting tools. This can be prevented by means of fixed spacers provided in the tool according to the invention.

The press according to the invention itself bends. In particular in the case of large presses, it is therefore important that the spacers be as close as possible to the cutting area defined by the cutting edges, so that cutting shock can be damped directly where it occurs. Otherwise, the cutting shock is damped in the area of the spacers, the press however is bent in other areas due to vibration, and damage occurs. Unlike conventional dampers for damping the cutting shock, the fixed spacers are able to completely damp movement of the press. Additionally, a cutting-shock shock absorber can be provided according to the invention on the spacer or abutment block. This shock absorber for damping cutting shock also brakes movement of the press before it is stopped by the press seating on the abutment or spacer.

Moreover, in a multistage tool in a press with a continuous movement of the press, several tools having several cutting areas and respective spacers can be provided that work with a time offset to each other. This way, the absolute value of the cutting force and thus, also the absolute value of the cutting shock and of the noise emission can be reduced.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1 is a partially schematic vertical section through a cutting press according to the invention;

FIGS. 2a-2c are smaller-scale views illustrating operation of the FIG. 1 press;

FIGS. 3a-3c are views like FIGS. 2a-2c showing a second press according to the invention;

FIGS. 4a-4c are views like FIGS. 2a-2c showing a third press according to the invention; and

FIGS. 4a-5c are views like FIGS. 2a-2c showing a fourth press according to the invention.

### SPECIFIC DESCRIPTION

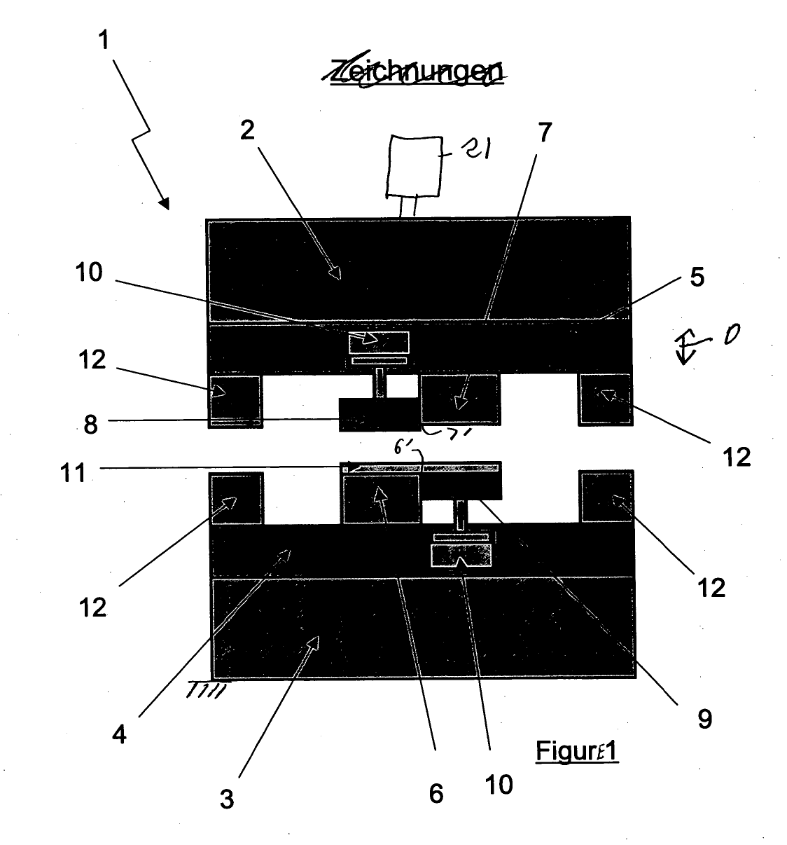

As seen in FIG. 1 a press 1 according to the invention has is represented in a section. A press upper plate 2 is shifted in vertical direction D by a schematically illustrated actuator 21 above a fixed lower plate 3. A lower tool 4 and an upper tool 5 are fixed to the press upper plate 2 and the press lower plate 3. The upper tool 5 is provided with an upper blade 7 having a straight-line cutting edge 7′. A hold-down element 8 is carried on the upper tool 5 and is biased downward by a hydraulic unit 10 to a normal position with its planar lower face slightly below a planar lower face of the blade 7. The lower tool 6 similarly carries a lower blade 6 having a straight-line cutting edge 6′. Another holding element 9 is carried on the lower tool 4 and is biased upward by another such hydraulic unit to a normal position with its planar upper face coplanar with a planar upper face of the blade 6. A workpiece 11 lies on the coplanar upper faces of the lower blade 6 and the element 9. The press 1 according to the invention has four fixed spacer blocks 12 that can stop a closing movement of the press 1. Two blocks 12 are fixed to the lower face of the upper tool 5 flanking the blade 7 and element 8 and two more on the upper face of the lower tool 4 flanking the blade 6 and element 9. The abutment blocks 12 are aligned in the direction D and have planar faces that abut each other in surface contact in a position with the cutting edge 6′ slightly below the cutting edge 7′. The hydraulic units 10 could be replaced with spring packs, pneumatic units, or the like.

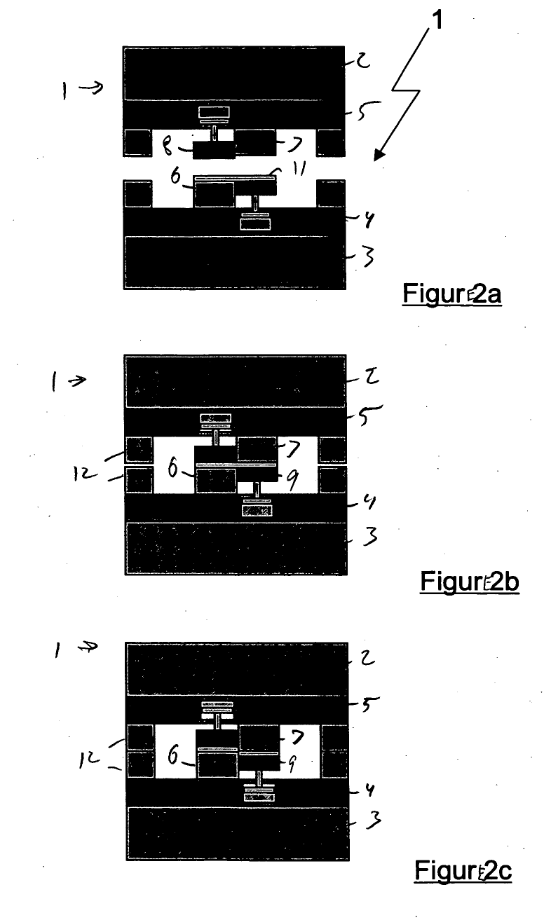

FIGS. 2a to 2c show the closing of the press 1. The workpiece 11 in the opened state of the press 1 is placed on the upper surfaces of blade 6 and the pressure pad or element 9. When the press upper plate 2 moves downward toward the press lower plate 3, the hold-down element 8 precedes the upper blade 7 (FIG. 2a) and engages the workpiece 11 for to clamp it against the tool 4.

When the upper blade 7 engages the workpiece 11 (FIG. 2b), the entire cutting force is applied along the entire length of the blades 6 and 7. In this position the cutting edges 6′ and 7′ bite slightly into the workpiece, but the spacers 12 are still spaced from each other by a distance equal to less than the workpiece thickness.

As shown in FIG. 2c, the workpiece 11 breaks along the cut line and the spacers 12 immediately engage each other and effectively stop the upper plate 2 before it can get up any speed. Even though stress in the press 1 is relieved because the cutting resistance is no longer present, the spacers 12 prevent any significant movement of the tools 4 and 5 in the cutting direction D. Furthermore the abutments 12 prevent contact of the blades 6 and 7 with each other. The blades 6, 7 can therefore be adjusted such that they have a cutting gap that is as small as possible, zero gap. With straight cutting edges 6′ and 7′, they lie in a common plane parallel to the direction D, here vertical. Thus, a fine cut is achieved that presents reduced formation of burrs on the workpiece 11. Moreover, the structure 1 according to the invention reduces noise and the cutting shock.

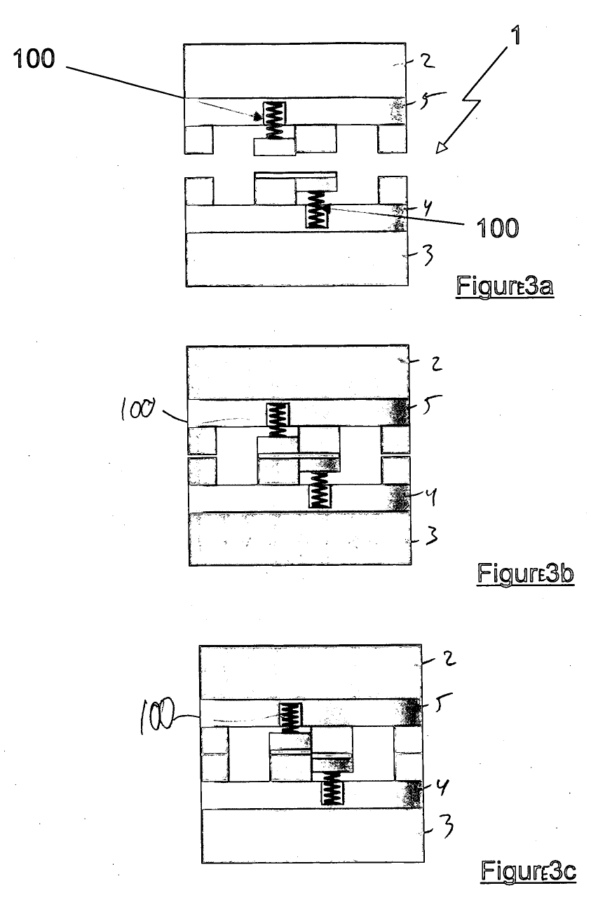

FIGS. 3a to 3c show the press 1 according to the invention during the closing with an alternative clamping-force generator 100, in this case a spring.

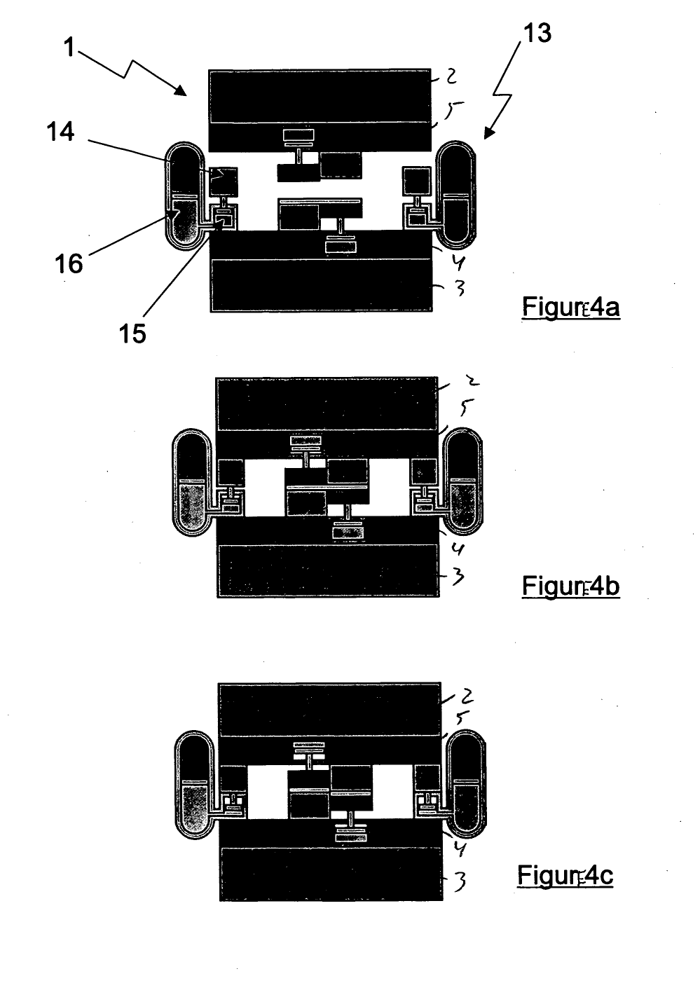

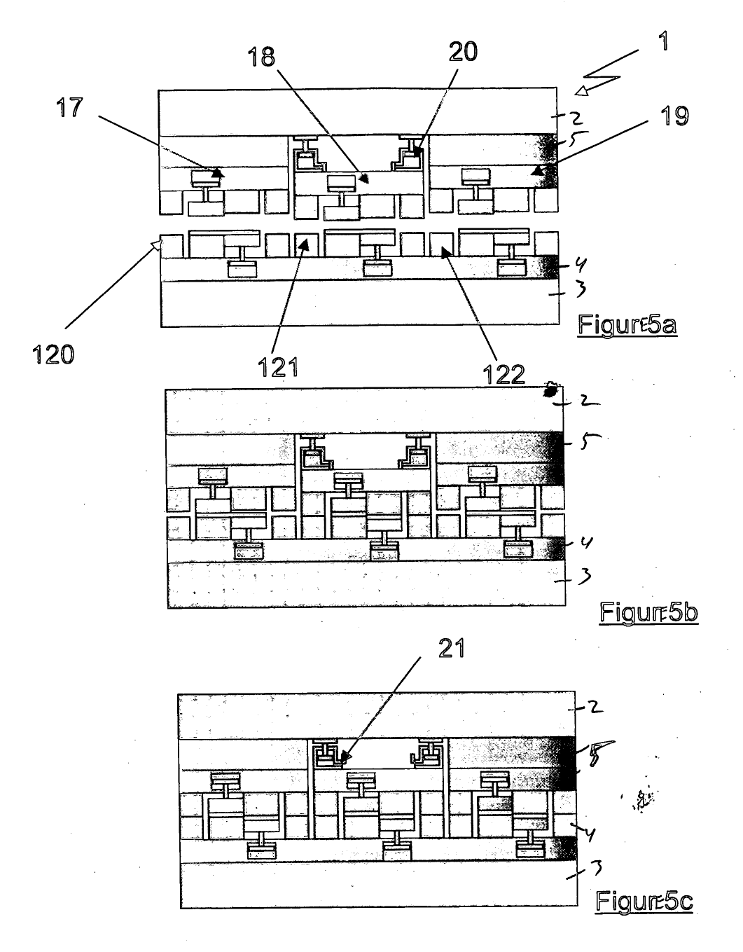

FIGS. 4a to c show another embodiment of the press 1 according to the invention during the closing movement. Instead of fixed spacers 12, an additional cutting-shock damper 13 is provided for the spacer or abutment 14. To this end the abutment 14 can move into relative to a small piston-cylinder unit also acting as abutment 15 along a limited path. This way, the abutment 14 for example displaces a fluid from the abutment/cylinder 15 into a fluid container 16 with pressure equalization. During the closing movement of the press 1, the upper tool 5 engages the abutment 14 and pushes it down against fluid force such that it seats on the abutment 15. The abutment 14 is pressed in direction of the abutment 15 during the cutting process and displaces the fluid that is in the abutment 15 (FIG. 4b). This way, the closing movement of the press 1 is slowed during fracturing of the workpiece 11 at first, and is subsequently reduced to zero by engagement of the abutment 14 with the abutment 15. Thus movement of the press is not only slowed down but stopped near the cutting area, in contrast to a conventional cutting-shock damper.

FIGS. 5a-5c show a further variant of the invention that is in particular used in multistage tools or large presses. Several tools 17, 18, 19 are attached to a press upper plate 2 that can be controlled separately from each other and that can be actuated. All the tools 17, 18, 19 are moved downward toward the press lower plate 3 by means of a single press upper plate 2. Each tool 17, 18, 19 has a cutting edge and a respective pair of tool spacers or abutments 120, 121, 122. Control of the tools 17, 18, 19 can for example be realized by via mechanical elements such as slides and cams.

In FIGS. 5a to 5c, the middle tool 18 is carried on a respective set of hydraulic cylinders 20 such that it cuts before the tools 17 and 19. Accordingly, the middle tool 18 is also the first to be placed on the spacers 121 assigned thereto. Thus way, the cutting force is applied by the hydraulic cylinders 20. After cutting by the tool 18, the tools 17 and 19 cut, subsequent movement of the press 1 being prevented by the fact that the tools 17 and 19 are engaged with the respective abutments 120 and 122. The residual press path is allowed by the middle tool 18 by means of the hydraulic cylinders 20 by the opening of valves 21 on the hydraulic cylinders 20 and thus, further outward displacement of the fluid therein is possible. In this manner, the absolute value of the cutting force and thus, also the cutting shock and the noise are reduced. The cutting work is applied over a longer distance with reduced force. Since for example mechanical presses can already reach their nominal force 12.5 mm before the lower dead center, the performance in this manner of the press 1 can be used in a more efficient manner.

We claim:

1. A power cutter for cutting a hardened steel workpiece, the cutter comprising:
upper and lower press plates shiftable vertically relative to each other;
a lower blade on the lower plate adapted to support the workpiece and having a lower cutting edge upwardly engaging the workpiece;
an upper blade on the upper plate having an upper cutting edge substantially parallel to and movable vertically past the lower cutting edge;
actuator means connected to one of the plates for vertically shifting the one plate toward and away from the other plate; and
an abutment on at least one of the plates for bearing on the other of the plates and blocking vertical shifting of the plates toward each other in a position with the upper cutting edge slightly above the lower cutting edge.

2. The power cutter defined in claim 1 wherein the edges are parallel to each other at all times.

3. The power cutter defined in claim 1 wherein the abutment is between the plates closely juxtaposed with the blades.

4. The power cutter defined in claim 1 wherein the abutment is provided with a shock absorber.

5. The power cutter defined in claim 1 wherein the upper cutting edge and the lower cutting edge are substantially vertically aligned and pass each other with substantially no clearance.

6. The power cutter defined in claim 1 wherein there are two such upper blades and two such lower blades, one of the upper blades and the respective one of the lower blade having their cutting edges oriented vertically above the other of the upper blades and the other of the lower blades.

7. The power cutter defined in claim 1, further comprising
upper holding means on the upper plate including a vertically shiftable upper holding element for pressing the workpiece against the lower blade; and
lower holding means on the lower plate including a vertically shiftable lower holding element for pressing the workpiece against the upper blade.

8. The power cutter defined in claim 7 wherein the upper holding means biases the upper holding element into a position below the upper cutting edge and the lower holding means biases the lower holding element into a position substantially level with the lower cutting edge, whereby the workpiece can be supported prior to cutting on the lower blade and lower holding element.

9. A method of cutting a hardened steel workpiece in a cutter having
upper and lower press plates shiftable vertically relative to each other;
a lower blade on the lower plate adapted to support the workpiece and having a lower cutting edge upwardly engaging the workpiece;
an upper blade on the upper plate having an upper cutting edge movable vertically past the lower cutting edge, the method comprising the steps of sequentially:
supporting the workpiece on the lower blade so that the workpiece extends across the lower cutting edge;
shifting the plates toward each other so that the cutting edges cut into the workpiece but do not move past each other;
pressing the blades together with the blades cutting into the workpiece until the workpiece fractures at the cutting edges; and
blocking further shifting-together of the blades by interposition of an abutment between them to prevent the cutting edges from passing each other.

10. The cutting method defined in claim 9 further comprising the step of
pressing the workpiece against one of the blades while shifting the plates toward each other.

11. The cutting method defined in claim 9 wherein the upper and lower cutting edges are oriented and vertically shifted in a common vertical plane.

12. The cutting method defined in claim 9 wherein the lower plate carries at least two such lower blades and the upper plate carries at least two such upper blades, the cutting edges of the blades being vertically offset.
